(19) United States
(12) Patent Application Publication
(10) Pub. No.: US 2026/0340262 A1
(43) Pub. Date: Oct. 29, 2026

(54) AUTOMATED INFORMATION CHECKING IN SYNTHESIZED TEXT DOCUMENT SUMMARIES

(71) Applicant: MICROSOFT TECHNOLOGY LICENSING, LLC, Redmond, WA (US)

(72) Inventor: Mrinal Kumar SHARMA, Noida (IN)

(21) Appl. No.: 19/188,810

(22) Filed: Apr. 24, 2025

(51) Int. Cl. G06F 40/166; G06F 40/30

(52) U.S. Cl. CPC G06F 40/166; G06F 40/30

(57) ABSTRACT

The techniques discussed herein are directed to real-time information checking when generating summaries of text documents. Generative artificial intelligence productivity tools are often used for summarizing content such a long text documents (e.g., research papers, legal filings, meeting transcripts). However, many existing artificial intelligence systems lack mechanisms for ensuring the content of the summaries they generate is accurate and/or complete. Consequently, this lack of functionality can lead to the propagation of inaccurate and/or misleading information as well as a disjointed, confusing user experience. To address this technical challenge, the present system and method provides mechanisms that enable generative artificial intelligence models to check the accuracy and/or completeness of information within text documents using a semantic comparison against information from trusted sources such as research institution databases. Moreover, the system provides functionality for seamlessly incorporating corrections into summaries to inform users of potentially inaccurate and/or incomplete information.

### BACKGROUND

Recent times have seen the proliferation of generative artificial intelligence-based (AI) productivity tools. Examples include tools for combing through massive amounts of data for analytics, generating text content for automated email answering, and implementing automated software testing suites. One particularly common use case is summarizing audiovisual content such a text document, an online meeting, and the like. In one example, a user that is overwhelmed with unread emails can invoke an artificial intelligence model to analyze their inbox and generate an organized summary. In another example, rather than reading a long text document, a user can upload the text document to an artificial intelligence tool and receive a summary laying out the main topics and/or arguments.

However, many artificial intelligence systems operate with a straightforward approach to summarization by assuming the original source of information (e.g., an uploaded text document) is truthful and/or accurate. That is, existing artificial intelligence systems often summarize information as it appears in the original source even if that information is inaccurate and/or misleading. For instance, a student may upload a research paper investigating climate change to an artificial intelligence summarization system. Unfortunately, the data and/or the methodology of the research paper may be outdated (e.g., relying on old climate models). Consequently, the conclusions following from the outdated data and/or methodology may be outdated likewise. In an artificial intelligence summarization system that lacks mechanisms for ensuring the content of summaries is accurate, these outdated conclusions may be presented at face value leading to the propagation of inaccurate and/or misleading information.

It is with respect to these and other considerations that the disclosure made herein is presented.

### SUMMARY

The techniques discussed herein are directed to real-time information checking when generating summaries of text documents (e.g., detecting inaccurate and/or incomplete information). As mentioned above, generative artificial intelligence (AI) productivity tools are often used for summarizing content such a long text documents (e.g., research papers, legal filings). However, many existing artificial intelligence systems lack mechanisms for ensuring the content of the summaries they generate is accurate and/or complete. For example, a student may upload a research paper investigating climate change to an artificial intelligence summarization system. Unfortunately, the data and/or the methodology of the research paper may be outdated (e.g., relying on old climate models). Consequently, the conclusions following from the outdated data and/or methodology may be outdated likewise. In an artificial intelligence summarization system that lacks information checking mechanisms, these outdated conclusions may be presented at face value leading to the propagation of inaccurate and/or misleading information. In another example, a student may upload a scan (e.g., an image) of a textbook for narration that may include missing information due to damage (e.g., torn pages, smeared text). Consequently, the textbook scan is incomplete which may lead to a summary that is disjointed, vague, and/or confusing.

To address this technical challenge, the present system and method provides mechanisms that enable generative artificial intelligence models to (i) check the accuracy and/or completeness of information when summarizing text documents and (ii) incorporate corrections and/or reconstructions in summaries to inform users of potentially inaccurate and/or incomplete information. In various examples, the system is initialized when receiving a text document that is uploaded from a user computing device (e.g., a laptop, a smartphone, a tablet). In response, the system scans the text document to extract structured text data using a first computational model (e.g., an artificial intelligence model).

Generally described, structured data is any data that is organized in a predefined format (e.g., a data model) such that the definition and/or meaning of the data is explicitly known (e.g., rows and columns in a database). This can include text that is arranged in tables, key-value pairs, or other formats that clearly define the relationships between different pieces of information. Consequently, structured data is readily decipherable by computational tools such as generative artificial intelligence models.

In contrast, unstructured data does not have a predefined data model (e.g., structure), making it challenging to collect, process and analyze using computational tools such as artificial intelligence models. For example, the text data in a document that one may upload for summarization such as a portable document format (PDF) file and/or handwritten text may be unstructured, meaning that the text data does not conform to a predefined structure that explicitly defines the meaning of every piece of data (e.g., every word, every letter, every image). By extracting structured text data from the unstructured text document, the system enables the application of computational tools such as artificial intelligence models for analyzing the semantic content of the text document.

Accordingly, the system identifies one or more factual claims conveyed by the previously extracted structured text data via a second computational model. That is, where the first computational model mentioned above can be an artificial intelligence model that is specifically configured for extracting structured text data, the second computational model can be an artificial intelligence model that is specifically configured for identifying and working with factual claims (e.g., named entities, historical events, logical arguments).

Once the factual claims of the text document are identified, the system deploys an information query across a plurality of trusted sources to retrieve verified information corresponding to the factual claims. In various examples, the selection of the trusted sources is configured based on the context of the factual claims. For example, a trusted source for a factual claim that – incorrectly – gives the date of the Apollo 11 moon landing as Jul. 19, 1969, can be the National Aeronautics and Space Administration (NASA). Moreover, the plurality of trusted sources can also be ranked by their respective credibility. For example, for a factual claim regarding space flight, NASA can be ranked above an online encyclopedia. Accordingly, information that is retrieved from the trusted sources can be weighted to resolve disagreements in the event of conflicting information.

The system then executes a semantic similarity comparison between the factual claims extracted from the text document and the verified information retrieved from the trusted sources to calculate a credibility score that quantifies a level of discrepancy between the factual claims and the verified information. In various examples, a lower credibility score can denote a greater level of discrepancy. For instance, a semantic similarity comparison will detect “Jul. 19, 1969” and “Jul. 20, 1969” as completely different dates with respect to the Apollo 11 moon landing resulting a low credibility score. However, it should be understood that any configuration for quantifying a level of discrepancy between the factual claims and the verified information can be utilized.

Accordingly, credibility score of the one or more factual claims is compared against a threshold credibility score. Generally described, the threshold credibility score represents a maximum level of acceptable discrepancy between the factual claims and the verified information. In various examples, alternative spellings, large scale date ranges (e.g., 2235 B.C.E – 2200 B.C.E), and variations in wording can be acceptable discrepancies. Conversely, factual errors (e.g., incorrect dates), debunked conspiracy theories, pseudoscience, and the like can be considered unacceptable discrepancies. If the credibility score of the factual claims does not satisfy the threshold credibility score, the system determines that the factual claims include inaccurate and/or misleading information.

In response, the system synthesizes a summary of the text document that incorporates a correction to the one or more factual claims in accordance with the verified information. For instance, a system that does not utilize the present techniques may generate a summary stating that the Apollo 11 moon landing occurred on Jul. 19, 1969, despite being factually incorrect. In contrast, the present system incorporates the correction into the summary stating that the Apollo 11 moon landing occurred on Jul. 20, 1969. Furthermore, incorporating the correction into the summary can be achieved using various output modalities (e.g., text, audio narration). For instance, a text summary can be corrected by editing a text output (e.g., changing “July 19” to “July 20”). In another example, an audio narration can be corrected by reconfiguring a vocal synthesis tool (e.g., an artificial intelligence model).

Subsequently, the system outputs the generated summary along with a fact-checking report that identifies any inaccurate information in the one or more factual claims of the text document, any corrections that were applied to the inaccurate information, and/or a source of the verified information (e.g., the plurality of trusted sources). As such, the fact-checking report enables the user to be informed of any changes the artificial intelligence system made to the factual claims rather than simply trust the output summary. Moreover, the fact-checking report can enable the user to provide feedback on corrections and/or adjust their corrections settings. For example, a young student may require more aggressive and/or stringent correction settings. Conversely, a subject expert may utilize more permissive settings as they may wish to simply identify factual claims presented by the text document. In this way, the system and method presented herein enables users to be better informed when utilizing artificial intelligence tools while countering and/or mitigating the spread of misinformation.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1A is a block diagram of one embodiment of a system for automated information checking while generating summaries of text documents using artificial intelligence models.

FIG. 1B is a block diagram of another embodiment of a system for automated information checking while generating summaries of text documents using artificial intelligence models.

FIG. 2 illustrates an example of a correction that is integrated into a summary by editing inaccurate information found in the text document.

FIG. 3 illustrates an example of a correction that is integrated into a summary by including a disclaimer explaining inaccurate information the text document.

FIG. 4 illustrates an example of a reconstruction of incomplete information in a summary.

FIG. 5 illustrates a fact-checking report user interface for providing feedback and/or editing correction settings.

FIG. 6 is a flow diagram showing aspects of a process for real-time fact-checking when synthesizing a summary of a text document.

FIG. 7 is a flow diagram showing aspects of a process for reconstructing incomplete information when synthesizing a summary of a text document.

FIG. 8 is a computer architecture diagram illustrating an illustrative computer hardware and software architecture for a computing system capable of implementing aspects of the techniques and technologies presented herein.

### DETAILED DESCRIPTION

The techniques discussed herein are directed to automated fact-checking when synthesizing summaries of text documents. As mentioned above, generative artificial intelligence (AI) productivity tools are often used for summarizing content such as long text documents (e.g., research papers, legal filings). However, many existing artificial intelligence systems lack mechanisms for ensuring the content of the summaries they generate is accurate and/or truthful. For example, a student may upload a research paper investigating climate change to an artificial intelligence summarization system. Unfortunately, the data and/or the methodology of the research paper may be outdated (e.g., relying on old climate models). Consequently, the conclusions following from the outdated data and/or methodology may be outdated likewise. In an artificial intelligence summarization system that lacks fact-checking mechanisms, these outdated conclusions may be presented at face value leading to the propagation of inaccurate and/or misleading information. To address this technical challenge, the present system and method provides mechanisms that enable generative artificial intelligence models to (i) check the accuracy and/or veracity of factual claims when summarizing text documents and (ii) incorporate corrections in summaries to inform users of potentially inaccurate and/or misleading information.

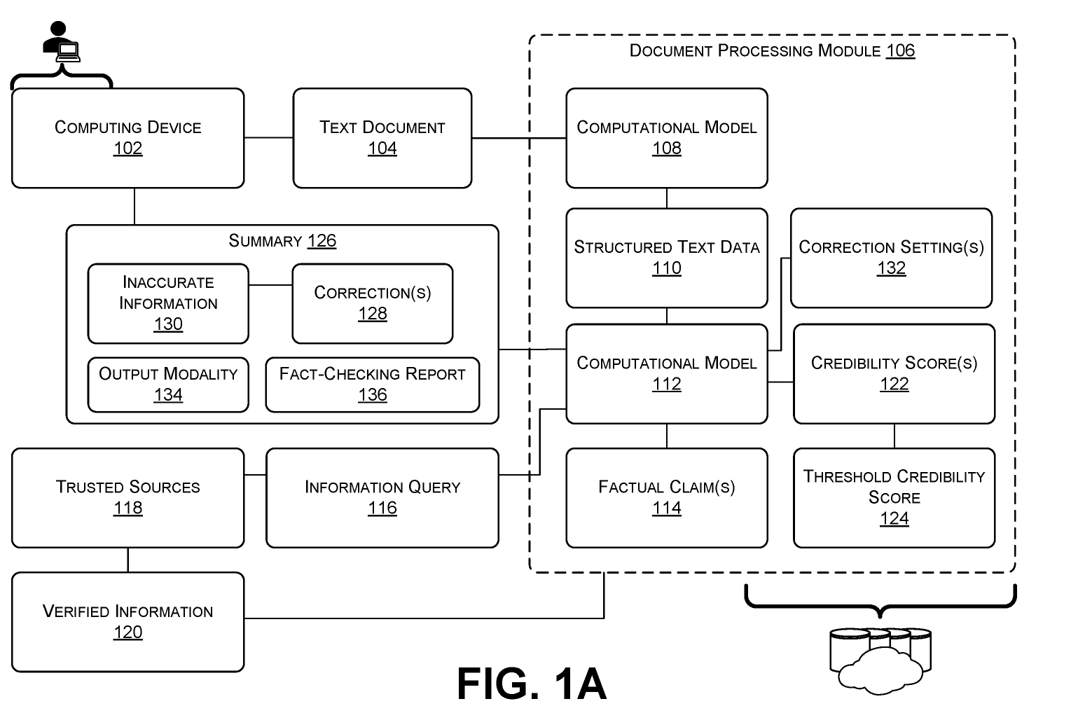

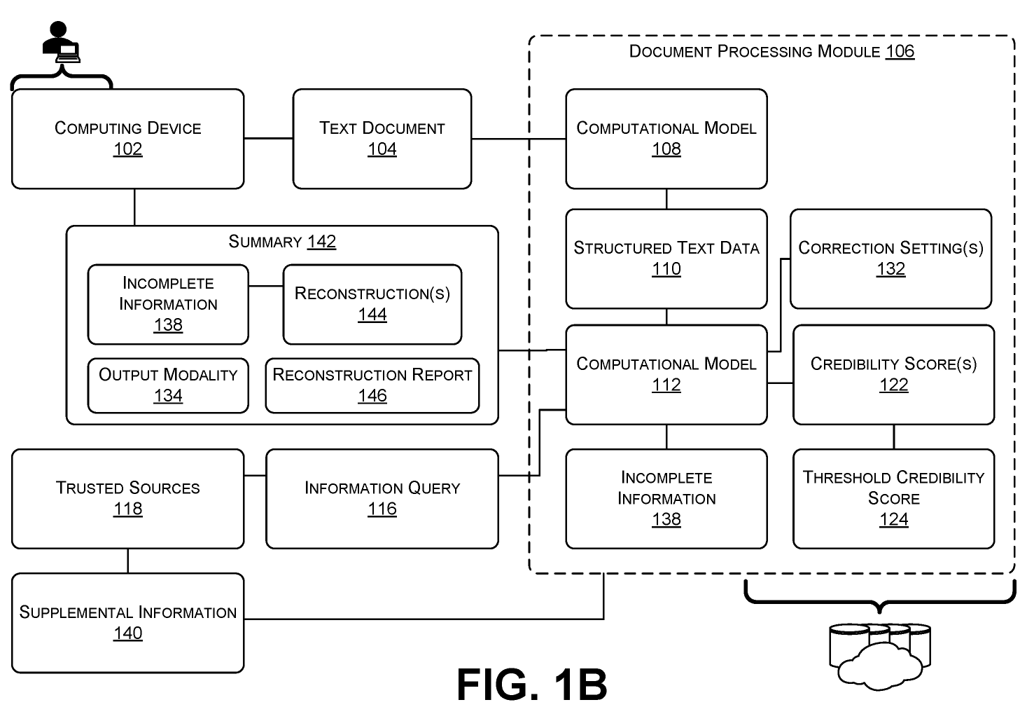

Various examples, scenarios, and aspects related to the techniques are described below with respect to FIGS. 1A-6.

FIG. 1A illustrates an information checking system in which a user at a computing device 102 (e.g., a laptop, a smartphone, a tablet) uploads a text document 104 to a document processing module 106 for summarization. In general, the text document 104 is a computer file that is configured as a sequence of lines of electronic text data. In some examples, such as a portable document format (PDF) file, the text document may contain image data in addition to text data. Accordingly, the document processing module 106 invokes an execution of a first computational model 108 to extract structured text data 110 from the text document 104.

As mentioned above, structured text data 110 is text data that is organized in a predefined format (e.g., a data model) such that the definition and/or meaning of the data is explicitly known (e.g., rows and columns in a database). This can include text that is arranged in tables, key-value pairs, or other formats that clearly define the relationships between different pieces of information. Consequently, structured data is readily decipherable by computational tools such as generative artificial intelligence models. In various examples, the first computational model 108 can be an optical character recognition (OCR) model that can extract structured text data 110 from text documents 104 that typically cannot be parsed by computational tools such as handwritten text, scanned documents from a printed source (e.g., a book), and images.

In another example, the first computational model 108 can be an artificial intelligence embedding model that is configured to generate embeddings of the text data contained in the text document 104 (e.g., a text embedding). Generally described, embeddings are mathematical structures (e.g., multidimensional vectors) that numerically represent the meaning of the text data contained in the text document 104 (e.g., the semantic content of the text document 104). Accordingly, embeddings enable artificial intelligence models to efficiently parse and analyze human-readable text content.

Subsequently, the document processing module 106 invokes execution of a second computational model 112 that is configured to identify one or more factual claims 114 that are conveyed by the structured data 108. Within the context of the present disclosure, a factual claim 114 is any statement that asserts something is objectively true or false based on evidence or reality. Examples of factual claims include information regarding named entities (e.g., people, places, historical events), findings and/or conclusions from a research publication, and the like. Consequently, factual claims are verifiable and/or falsifiable based on empirical evidence. For example, a factual claim 114 stating that “the Apollo 11 mission landed on the moon on Jul. 19, 1969” is provably false as documentation of the Apollo 11 mission itself shows that the Apollo 11 astronauts touched down on the moon on Jul. 20, 1969.

In various examples, the second computational model 112 is an artificial intelligence model that parses the structured text data 110 to identify the factual claims 114 based on a semantic analysis. In a specific example, the second computational model 112 is a language model (e.g., a large language model, a small language model, a multimodal language model). Generally described, a language model is a machine learning algorithm implementing a statistical representation of natural language. Accordingly, the language model is trained on large amounts of text data, image data, and/or other data to learn statistical relationships between individual tokens (e.g., words, characters, phrases).

For instance, the language model can be trained to predict tokens in sequences of textual training data. Consequently, the language model achieves predictive capability with respect to vague and/or typically nebulous aspects inherent to natural language such as syntax, semantics, and ontologies. Subsequently, when employed in inference mode, the output of the language model can include new sequences of text that the model generates (e.g., a recap summary output). In this way, language models are especially well-suited for analyzing the complex and often nebulous relationships inherent in human-readable text.

Moreover, the document processing module 106 can invoke the second computational model 112 using an input instruction (e.g., a prompt). Generally described, a prompt refers to any input provided to the computational model 112 that causes the computational model 112 to generate an output. A prompt can be provided in various modalities, such as text, an image, audio, video, and so forth. For instance, a “language generation prompt” is an input to the computational model where the requested output is in the form of natural language. Likewise, an “audio generation prompt” is any input to the computational model 112 where the requested output is in the form of an audio file (e.g., an auditory narration). In various examples, a prompt is input to the computational model 112 as a natural language command (e.g., “Generate a summary of the attached document and output an auditory narration of the summary”).

Once the second computation model 112 identifies the one or more factual claims 114 from the structured text data 110, the second computational model 112 begins fact checking the factual claims 114 by deploying an information query 116 to a preconfigured plurality of trusted sources 118. A trusted source 118 is any information source that has a well-established history of credibility and lack of bias. Examples of trusted sources 118 include institutional databases (e.g., educational institutions, research institutions), government agencies, news organizations, research publications (e.g., journals), encyclopedias, and the like.

In various examples, the plurality of trusted sources 118 for the information query 116 are selected by the computational model 112 from a preconfigured list based on their relevance to the factual claim 114 that is being checked. For example, consider a factual claim 114 regarding climate change. Upon detecting the subject matter of the factual claim 114 from the aforementioned semantic analysis, the computational model 112 can deploy an information query 116 to databases belonging to well-known climate science organizations such as the National Oceanic and Atmospheric Administration (NOAA) of the United States, the National Aeronautics and Space Administration (NASA) of the United States, the Intergovernmental Panel on Climate Change (IPCC), and so forth to request verified information 120 pertaining to the factual claim 114. In various examples, the verified information 120 can include text data, image data, multimedia data, or any other suitable format of information.

Moreover, the complexity of the information query 116 can vary based on the factual claim 114 being checked. For example, the information query 116 for checking the date of a historical event can be a simple request for a specific piece of verified information 120 (e.g., the date of the Apollo 11 moon landing). Alternatively, a factual claim 114 asserting that the crewed moon landings were a hoax can result in a comparatively complex information query 116 that retrieves several pieces of verified information 120.

Furthermore, computational model 112 can rank the plurality of trusted sources 118 based on a reliability metric that is calculated for each of the plurality of trusted sources 118. In various examples, the reliability metric is a weighted aggregate score that incorporates factors such as the relevance of the trusted source 118 to the factual claim 114, subject matter expertise, institutional history, availability of primary source information, frequency of retractions, and so forth. In this way, the computational model 112 can retrieve the most accurate for of the verified information 120 in the event of disagreement among the trusted sources 118. For example, consider a factual claim 114 reporting on a company’s quarterly earnings (e.g., “revenue for Q3 2024 was $2.1 billion”). In this example, the plurality of trusted sources 118 can include accounting data retrieved from an internal company database prior to compilation into an official report (e.g., “revenue for Q3 2024 was $2.15 billion”) and filings with the United States Securities and Exchange Commission (e.g., “revenue for Q3 2024 was $2.05 billion”). Accordingly, the United States Securities and Exchange Commission can be a higher ranked (e.g., more credible) trusted source 118 in relation to the internal company database due to its stringent requirements with respect to financial disclosures.

After retrieving the verified information 120, the computational model 112 can execute a semantic similarity comparison between the factual claims 114 of the structured text data 110 and the verified information 120 retrieved from the plurality of trusted sources 118 to calculate a credibility score 122. Within the context of the present disclosure, the credibility score 122 quantifies a level of semantic discrepancy between the one or more factual claims 114 and the verified information 120. In various examples, a higher credibility score 122 indicates greater concurrence between the factual claims 114 and the verified information 120 in relation to a lower credibility score 122. For instance, the credibility score 122 can range between “0” and “10” with a credibility score 122 of “0” indicating complete disagreement between the factual claims 114 and the verified information 120 and a credibility score 122 of “10” indicating complete agreement between the factual claims 114 and the verified information 120.

Subsequently, the document processing module 106 compares the credibility score 122 of the factual claims 114 against a threshold credibility score 124. Generally described, the threshold credibility score 124 defines a maximum acceptable level of semantic discrepancy between the factual claims 114 and the verified information 120. Consequently, a credibility score 122 that does not satisfy the threshold credibility score 124 indicates a factual claim 114 that contains inaccurate and/or misleading information that will be corrected by the computational model 112 during summarization.

Accordingly, the computational model 112 can synthesize a summary 126 of the text document 104 presenting the one or more factual claims 114 with corrections 128 applied to any inaccurate information 130 identified via the aforementioned credibility score 122. In various examples, the modality in which the corrections 128 are incorporated into the summary 126 can be adjusted with respect to user-configured correction settings 132. For example, consider a factual claim 114 that incorrectly gives the date of the Apollo 11 moon landing stating, “Apollo 11 touched down on the moon on Jul. 19, 1969.” In one configuration, the correction settings 132 cause the computational model 112 to present the corrections 128 as direct edits to the factual claim 114. That is, the applying corrections 128 comprises a rephrasing of the factual claim in which the inaccurate information 130 is replaced with the verified information 120. Consequently, the summary 126 can instead state that “Apollo 11 touched down on the moon on Jul. 20, 1969.” In another configuration, the correction settings 132 cause the computational model 112 to present the corrections 128 as a statement accompanying the inaccurate information 130 of the factual claim 114. In this example, the summary 126 can state that “the document states that Apollo 11 touched down on the moon on Jul. 19, 1969. However, records from NASA show that Apollo 11 touched down on the moon on Jul. 20, 1969.”

Furthermore, the computational model 112 synthesizes the summary 126 using a predefined output modality 134 (e.g., text, audio, multimedia). In various examples, the output modality 134 is defined by an input instruction to the computational model 112 such as an audio generation prompt and/or a language generation prompt as mentioned above. In one example, the output modality is an auditory narration of the summary 126 (e.g., an AI-generated podcast) comprising synthesized speech audio data that communicates the semantic content of the text document 104 as well as the corrections 128 to the inaccurate information 130 present in the factual claims. That is, the computational model 112 is configured to dynamically adjust the auditory narration during output to incorporate the corrections 128 in a natural-sounding manner. Moreover, the computational model 112 can utilize a specialized text-to-speech artificial intelligence model to synthesize the speech audio that naturally blends the corrections 128 into the summary 126 by adjusting tone, intonation, and pacing to mimic human speech.

In addition, the summary 126 includes a fact-checking report 136 that distinctly identifies the inaccurate information 130 of the factual claims 114 and the corrections 128 as well as the trusted sources 118 that provided the verified information 120. That is, while the computational model 112 seamlessly incorporates the corrections 128 into the summary 126, the fact-checking report 136 enables the user to clearly see where the corrections 128 are applied and the inaccurate information 130 being corrected. As will be elaborated upon below, the fact-checking report 136 can graphically distinguish between the inaccurate information 130 and the corrections 128. Furthermore, the fact-checking report 136 can also enable the user to provide feedback on the corrections 128 and dynamically adjust the correction settings 132 in response based on user preferences. In this way, the document processing module 106 can ensure that the summary 126 contains accurate, well-sourced information while also providing transparency to the end user with respect to the corrections 128 and the trusted sources 118 of the verified information 120.

Proceeding to FIG. 1B, aspects of an alternative embodiment of the system discussed above are shown and described. For instance, while the example of FIG. 1A is directed to fact-checking a factual claim against verified information, the example of FIG. 1B is directed to detecting incomplete information 138 in the text document 104. In various examples, the computational model 112 can identify incomplete information 138 by detecting abrupt transitions between paragraphs (e.g., missing paragraphs), uncited arguments (e.g., missing legal citations), damaged text (e.g., faded text, smeared text), and/or any other suitable indication of incomplete information 138.

In response to identifying the incomplete information 138, the computational model 112 can determine, based on the context of the structed text data 110, what information is missing from the text document 104. For example, the text document 104 may state that “on Jul. 19, 1969, Apollo 11 fired its service propulsion engine to enter lunar orbit. The next day, astronauts…… landed on the moon.” Clearly, the incomplete information 138 is the names of the Apollo 11 astronauts that landed on the moon. Accordingly, the computational model 112 can deploy an information query 116 to a plurality of trusted sources 118 to retrieve supplemental information 140 to fill in the incomplete information 138. As mentioned above, the trusted sources 118 can include institutional databases (e.g., educational institutions, research institutions), government agencies, news organizations, research publications (e.g., journals, archives), encyclopedias, and the like. In this way, the document processing module 106 can ensure that the supplemental information 140 is reliable and/or accurate.

After retrieving the supplemental information 140 from the trusted sources the computational model 112 can synthesize a summary 142 of the text document 104 that includes a reconstruction 144 of the incomplete information 138 using the supplemental information 140. For instance, continuing with the above example, the summary 142 can state that “on Jul. 19, 1969, Apollo 11 fired its service propulsion engine to enter lunar orbit. The next day, astronauts Neil Armstrong and Buzz Aldrin landed on the moon.” That is, computational model 112 can incorporate the reconstruction 144 of the incomplete information 138 to provide a seamlessly user experience. For instance, as mentioned above, the output modality 134 can be an auditory narration of the summary 142 (e.g., an AI-generated podcast) comprising synthesized speech audio data that communicates the semantic content of the text document 104. By smoothly incorporating the reconstruction 144, the auditory narration flows naturally without abrupt breaks and/or unnatural gaps. Likewise, the computational model 112 can adjust tone, intonation, and/or pacing to mimic human speech to further improve the listening experience.

Furthermore, a reconstruction report 146 that is included in the summary 142 can distinctly identify the incomplete information 138 and the reconstruction 144 that was generated by the computational model 112 to provide transparency. For instance, the user can manually review and/or approve the reconstruction 144 to further ensure accuracy and/or correctness. Moreover, the reconstruction report 146 can include a confidence score that is calculated by the computational model 112 to quantify the likelihood of correctness of the reconstruction 144. In this way, the document processing module 106 can prevent the spread of inaccurate and/or misleading information when generating reconstructions 144 of incomplete information 138.

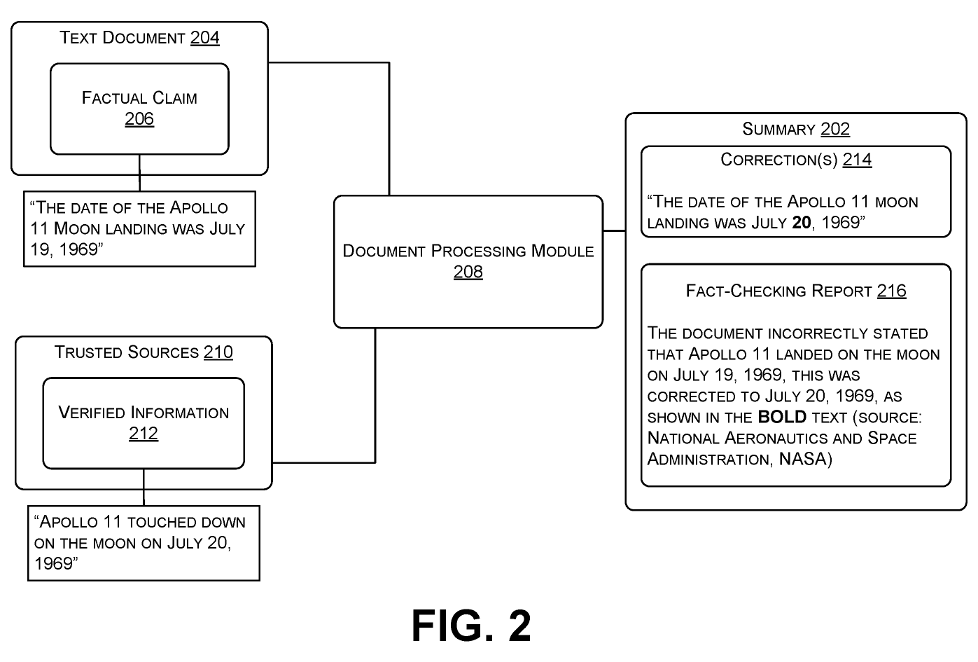

Turning now to FIG. 2, an example of synthesizing a summary 202 for the text document 204 containing an incorrect and/or misleading factual claim 206 is shown and described. In the present example, the factual claim 206 states that “the date of the Apollo 11 moon landing was Jul. 19, 1969.” Accordingly, the factual claim 206 is identified by a document processing module 208 and checked using an artificial intelligence-based process such as the example described above with respect to FIG. 1A.

As such, the document processing module 208 queries a plurality of trusted sources 210 to retrieve verified information 212 that lists the date of the Apollo 11 moon landing. As mentioned above, the plurality of trusted sources 210 can be selected based on the relevance of their information to the factual claim 206. For instance, a factual claim 206 regarding the Apollo 11 moon landing can cause the document processing module 208 to query NASA, well-known encyclopedias, and so forth. Moreover, the document processing module 208 can rank the trusted sources 210 based on their credibility as mentioned above to ensure retrieval of high-quality information. For example, NASA can be prioritized among the trusted sources 210 due to being a primary source for the Apollo 11 mission.

In response to the query by the document processing module, the trusted sources 210 can return verified information 212 that gives the date of the Apollo 11 moon landing as “Jul. 20, 1969.” Upon executing a semantic similarity comparison between the factual claim 206 and the verified information 212, the document processing module 208 can detect that the factual claim 206 and the verified information 212 disagree on the date of the Apollo 11 moon landing. Accordingly, the summary 202 includes a correction 214 to the factual claim 206 that changes the listed date from “Jul. 19, 1969” to “Jul. 20, 1969”. That is, the document processing module 208 is configured (e.g., by correction settings) to apply the correction 214 by directly editing the inaccurate information of the factual claim 206 to incorporate the verified information 212 as described above. Furthermore, the summary 202 includes a fact-checking report 216 describing the inaccuracy of the factual claim 206 (e.g., an incorrect date), the nature of the correction 214 (e.g., an edit to the factual claim 206), and a graphical distinction between the factual claim 206 and the verified information 212 (e.g., bold text).

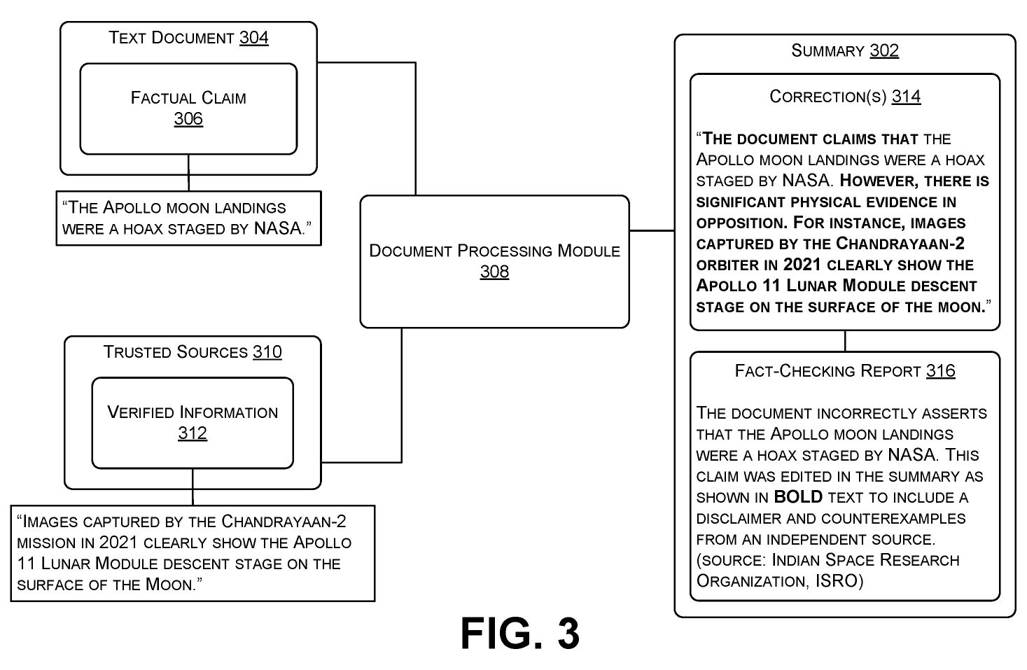

Proceeding to FIG. 3, an example of synthesizing a summary 302 for a text document 304 containing an incorrect and/or misleading factual claim 306 is shown and described. In this example, the text document 304 includes a factual claim 306 asserting that “the Apollo moon landings were a hoax staged by NASA” as part of a broader conspiracy to deceive the public. Similar to the example of FIG. 2 above, a document processing module 308 can detect the factual claim 306 and check its veracity by querying a plurality of trusted sources 310 for verified information 312.

As described above, the document processing module 308 can select and/or rank the plurality of trusted sources 310 based on their relevance to the semantic content of the factual claim 306. For instance, like in the above example, NASA can be selected as a trusted source 310 and prioritized in ranking due to being a primary source for the Apollo moon landings and its longstanding history of credibility. Likewise, other institutions that have carried out well-documented lunar exploration missions can be included in the trusted sources such as the European Space Agency (ESA), the Japan Aerospace Exploration Agency (JAXA), and the Indian Space Research Organisation (ISRO).

In some examples however, the document processing module 308 may adjust the ranking of the trusted sources 310 in response to factual claims 306 that include controversial and/or contentious subject matter, especially when regarding specific entities (e.g., an organization, an individual). For instance, the example factual claim 306 asserts that NASA in particular staged the alleged hoax. In response, the artificial intelligence-based document processing module 308 can prioritize verified information 312 from other credible trusted sources 310 (e.g., ESA, JAXA, ISRO) over NASA due to their independence from the controversial and/or contentious subject matter of the factual claim 306.

As shown in FIG. 3, the verified information 312 states, at least in part, that “images captured by the Chandrayaan-2 mission in 2021 clearly show the Apollo 11 Lunar Module descent stage on the surface of the moon.” Accordingly, a semantic similarity comparison between the factual claim 306 and the verified information 312 can show significant semantic disagreement thereby necessitating a correction 314. Consequently, when synthesizing the summary 302, the document processing module 308 applies a correction 314 to the inaccurate information of the factual claim 306. In the present example, the document processing module 308 is configured (e.g., by correction settings) to apply the correction 314 by presenting the factual claim 306 alongside a disclaimer and evidence refuting the factual claim 306.

In addition, the summary 302 includes a fact-checking report 316 showing the inaccurate and/or misleading nature of the factual claim 306 as well as the correction 314 applied by the document processing module 308 by graphically distinguishing the factual claim 306 and the correction 314 (e.g., in bold text). Moreover, the fact-checking report 316 identifies the source of the verified information 312. In this way, the document processing module 308 enables users to quickly detect inaccurate and/or misleading information while providing transparency with respect to the way in which corrections 314 are applied. Consequently, the document processing module 308 enables users consuming the synthesized summary 302 can be well-informed with respect to available evidence without necessarily censoring controversial and/or contentious information.

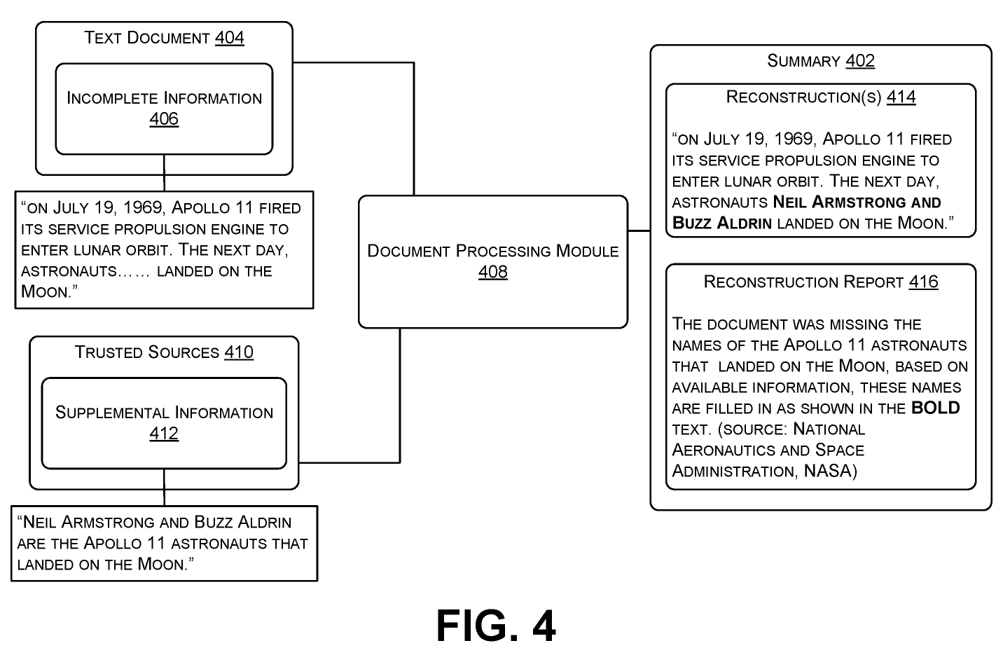

Turning now to FIG. 4, an example of synthesizing a summary 402 for a text document 404 containing incomplete information 406 is shown and described. In the present example, the incomplete information 406 states, “on Jul. 19, 1969, Apollo 11 fired its service propulsion engine to enter lunar orbit. The next day, astronauts…… landed on the moon” indicating that the names of the Apollo 11 astronauts that landed on the Moon are missing. As mentioned above, the document processing module 408 can identify incomplete information 406 by detecting abrupt transitions between paragraphs (e.g., missing paragraphs), uncited arguments (e.g., missing legal citations), damaged text (e.g., faded text, smeared text), and/or any other suitable indication within the text document 404 of incomplete information 406.

To reconstruct the incomplete information 406, the document processing module 408 queries a plurality of trusted sources 410 to retrieve supplemental information 412 with which to reconstruct the incomplete information 406. As mentioned above, the plurality of trusted sources 410 can be selected based on the relevance of their information to the factual claim 406. For instance, a text document 404 regarding the Apollo 11 moon landing can cause the document processing module 408 to query NASA, well-known encyclopedias, historical archives and so forth. Moreover, the document processing module 408 can rank the trusted sources 410 based on their credibility as mentioned above to ensure retrieval of high-quality information. For example, NASA can be prioritized among the trusted sources 410 due to being a primary source for the Apollo 11 mission.

In response to the query from the document processing module 408, the trusted sources 410 can return supplemental information 412 that includes the names of the Apollo 11 astronauts (i.e., “Neil Armstrong and Buzz Aldrin”). Accordingly, the summary 402 of the text document 404 includes a reconstruction 414 of the incomplete information 406 stating that “astronauts Neil Armstrong and Buzz Aldrin landed on the moon.” Furthermore, the summary 402 includes a reconstruction report 416 that identifies the incomplete information 406 (e.g., missing names), the nature of the reconstruction 414 (e.g., filling in missing names using supplemental information 412), and a graphical distinction between the incomplete information 406 and the supplemental information 412 (e.g., bold text).

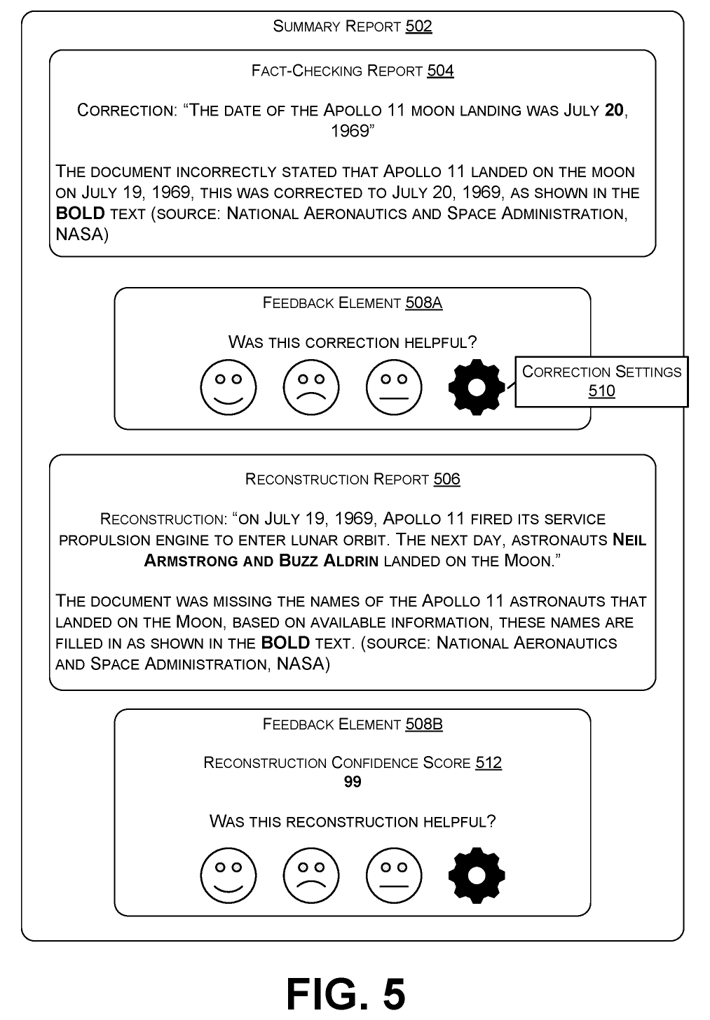

Proceeding to FIG. 5, aspects of an example user interface for interacting with a summary report 502 associated with an AI-generated summary of a text document are shown and described. As mentioned above, AI-generated summaries of a text documents can include AI-generated corrections and/or reconstructions using information from trusted sources to counter inaccurate and/or misleading factual claims and/or fill in incomplete information. In various examples, these corrections and/or reconstructions are seamlessly incorporated into the summary by editing, rewording, amending, or otherwise altering the semantic content of the text document to ensure a low-friction user experience. However, to maintain transparency and/or accountability with respect to AI-generated corrections, the summary report 502 distinctly identifies any changes made by the summarization system (e.g., a document processing module). Moreover, the summary report 502 can also identify the trusted sources that provided the information used in the corrections and/or the reconstructions.

As shown in FIG. 5, the summary report 502 includes a fact-checking report 504 and a reconstruction report 506. For example, the fact-checking report 504 states that “the document incorrectly stated that Apollo 11 landed on the moon on Jul. 19, 1969, this was corrected to Jul. 20, 1969, as shown in the BOLD text.” In this way, the fact-checking entry 504 distinctly identifies the inaccurate information of the factual claim (e.g., “incorrectly stated that Apollo 11 landed on the moon on Jul. 19, 1969”), the correction that was applied using verified information (e.g., “this was corrected to Jul. 20, 1969”), graphically distinguishes between the inaccurate information and the correction (e.g., “as shown in the BOLD text”), and the source of the verified information (e.g., “source: National Aeronautics and Space Administration, NASA”). It should be understood that the corrections can be graphically distinguished from the inaccurate information in any suitable format (e.g., changing typeface, changing text color, highlighting).

Likewise, the reconstruction report 506 states that “the document was missing the names of the Apollo 11 astronauts that landed, based on available information, these names are filled in as shown in the BOLD text.” In this way, the reconstruction report 506 identifies the incomplete information (e.g., “the document was missing the names of the Apollo 11 astronauts that landed on the Moon”), the nature of the reconstruction (e.g., “based on available information, these names are filled in”), graphically distinguishes the incomplete information and the reconstruction (e.g., “as shown in the BOLD text”), and a source of the supplemental information used in the reconstruction (e.g., “source: National Aeronautics and Space Administration, NASA”).

Moreover, the fact-checking report 502 includes feedback elements 508A and 508B corresponding to each of the fact checking report 504 and reconstruction report 506 respectively that enable the user to provide feedback. For instance, the user can select (e.g., via click, tap, voice command) an emoticon to indicate whether an associated correction reconstruction was helpful. Furthermore, the feedback element 508A can provide access to correction settings 508 in which the user can configure preferences with respect to correction style (e.g., direct editing, attaching a disclaimer), types of factual claims to target for correction (e.g., incorrect dates, misinformation), preferred output modality (e.g., auditory narration, text), and so forth. In addition, the feedback element 508B includes a reconstruction confidence score 512 quantifying a likelihood of correctness of the AI-generated reconstruction thereby enabling the user to gauge the trustworthiness of the AI-generated reconstruction. In this way, the fact-checking report 502 enables users to gain insight into the information they consume while providing an intuitive and/or customizable user experience.

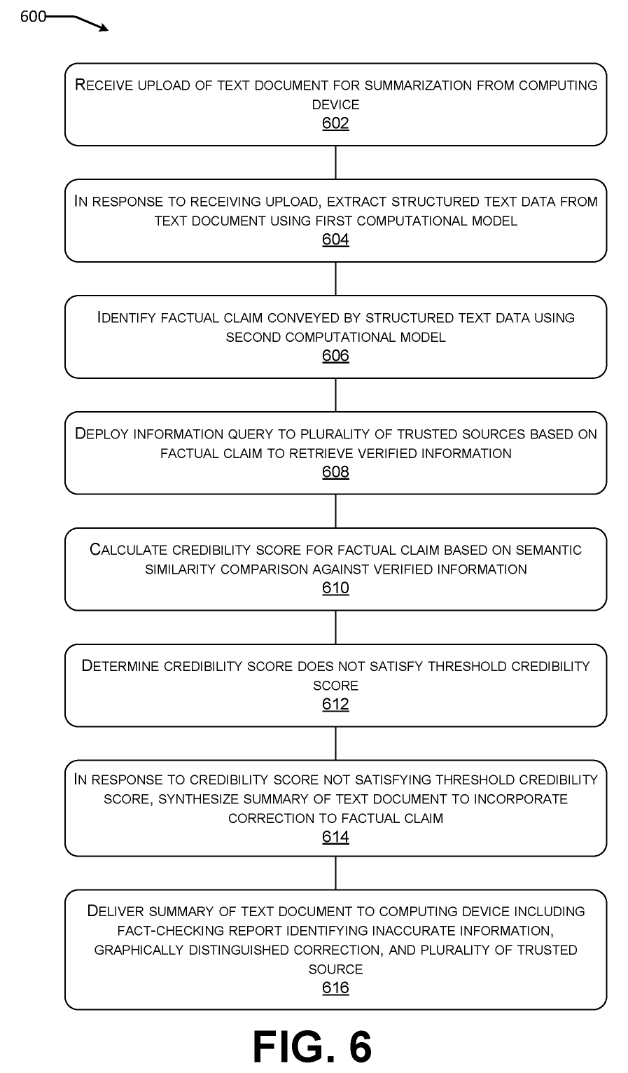

Turning now to FIG. 6, aspects of a process 600 for real-time fact-checking when synthesizing a summary of a text document are shown and described. With respect to FIG. 6, the process 600 begins at operation 602 where a system (e.g., a document processing module) receives an upload of a text document for summarization from a user at a computing device (e.g., a laptop, a tablet, a smartphone).

Next, at operation 604, in response to receiving the upload of the text document, the system extracts structured text data from the text document by executing a first computational model. As mentioned above, structured data is any data that is organized in a predefined format (e.g., a data model) such that the definition and/or meaning of the data is explicitly known. Consequently, structured data is readily decipherable by computational tools such as generative artificial intelligence models. In various examples, the first computational model can be an optical character recognition (OCR) model that can extract structured text data from text documents 104 that typically cannot be parsed by computational tools such as handwritten text, scanned documents from a printed source (e.g., a book), and images. In another example, the first computational model 108 can be an artificial intelligence embedding model that is configured to generate embeddings of the text data contained in the text document 104 (e.g., a text embedding).

Then, at operation 606, the system identifies a factual claim conveyed by the structured text data via execution of a second computational model. As described above, the second computational model can be a language model (e.g., a large language model, a small language model, a multimodal language model). Generally described, a language model is a machine learning algorithm implementing a statistical representation of natural language. Accordingly, the language model is trained on large amounts of text data, image data, and/or other data to learn statistical relationships between individual tokens (e.g., words, characters, phrases). Consequently, the language model achieves predictive capability with respect to vague and/or typically nebulous aspects inherent to natural language such as syntax, semantics, and ontologies.

Subsequently, at operation 608, the system deploys an information query to a plurality of trusted sources based on the factual claim to retrieve verified information corresponding to the factual claim. In various examples, the selection of the trusted sources to query is based on the context of the factual claim. For example, the information query for a factual claim regarding space travel can query publicly available databases of national space agencies such as NASA, ESA, JAXA, ISRO, and the like.

Next, at operation 610, the system calculates a credibility score for the factual claim based on a semantic comparison against the verified information retrieved via the information query. As mentioned above, the credibility score quantifies a level of discrepancy between the semantic content (e.g., the meaning) of the factual claim and the semantic content of the verified information. In some configurations, a low credibility score can indicate a high level of discrepancy.

Proceeding to operation 612, the system determines that the credibility score does not satisfy a threshold credibility score. In various examples, the threshold credibility score represents a maximum level of acceptable discrepancy between the factual claims and the verified information. In various examples, alternative spellings, large scale date ranges (e.g., 2236 B.C.E – 2200 B.C.E), and variations in wording can be acceptable discrepancies. Conversely, factual errors (e.g., incorrect dates), debunked conspiracy theories, pseudoscience, and the like can be considered unacceptable discrepancies.

Then, at operation 614, in response to determining that the credibility score of the factual claim does not satisfy the threshold credibility score, the system synthesizes a summary of the text document that incorporates a correction to the factual claim in accordance with the verified information. As described above, incorporating the correction can be achieved in various ways and can be configured by user preferences. In one example, the correction is incorporated as a rephrasing of the factual claim in which the inaccurate information of the factual claim is replaced by the verified information.

Finally, at operation 616, the system delivers the summary of the text document to the computing device. Moreover, the summary includes a fact-checking report that distinctly identifies the inaccurate information of the factual claim, the correction in accordance with the verified information, which is graphically distinct from the inaccurate information, and at least one of the plurality of trusted sources that provided the verified information. In a specific example, the correction is graphically distinguished from inaccurate information by rendering the correction in BOLD text.

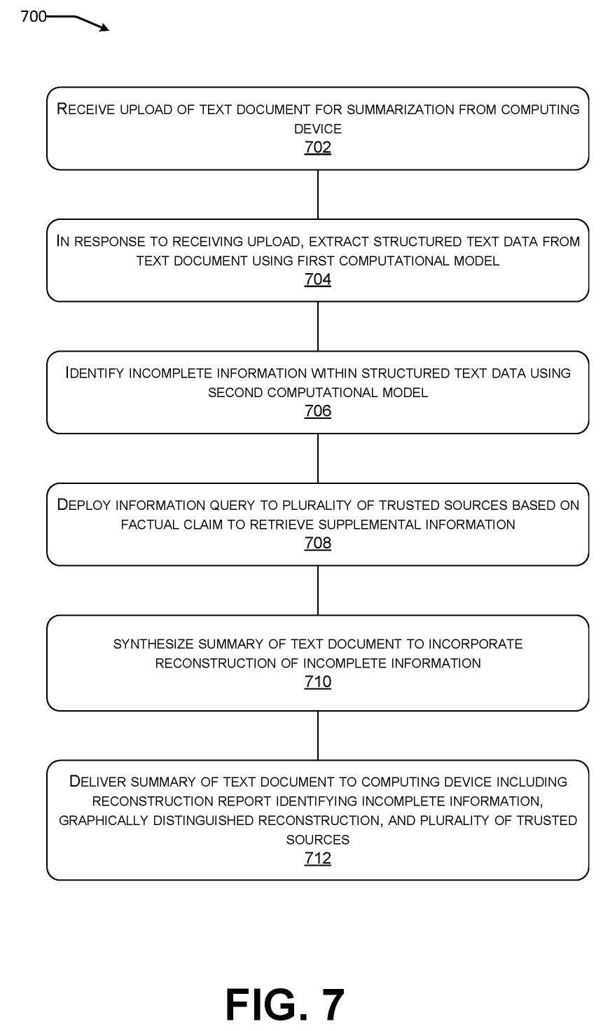

Turning now to FIG. 7, aspects of a process 700 for reconstructing incomplete information when synthesizing a summary of a text document are shown and described. With respect to FIG. 7, the process 700 begins at operation 702 where a system (e.g., a document processing module) receives an upload of a text document for summarization from a user at a computing device (e.g., a laptop, a tablet, a smartphone).

Next, at operation 704, in response to receiving the upload of the text document, the system extracts structured text data from the text document by executing a first computational model.

Then, at operation 706, the system identifies incomplete information within the structured text data using a second computational model. As mentioned above, the second computational model can identify incomplete information by detecting abrupt transitions between paragraphs (e.g., missing paragraphs), uncited arguments (e.g., missing legal citations), damaged text (e.g., faded text, smeared text), and/or any other suitable indication of incomplete information.

Subsequently, at operation 708, the system deploys an information query to a plurality of trusted sources based on the factual claim to retrieve verified information corresponding to the incomplete information. In various examples, the selection of the trusted sources to query is based on the context of the factual claim. For example, the information query for a factual claim regarding space travel can query publicly available databases of national space agencies such as NASA, ESA, JAXA, ISRO, and the like.

Next, at operation 710, the system synthesizes a summary of the text document that incorporates a reconstruction of the incomplete information in accordance with the supplemental information.

Finally, at operation 712, the system delivers the summary of the text document to the computing device. Moreover, the summary includes a reconstruction report that distinctly identifies the incomplete information, the reconstruction of the incomplete information, which is graphically distinguished from the incomplete information, a reconstruction confidence score, and at least one of the plurality of trusted sources.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated method can begin and/or end at any time and need not be performed in its entirety. Some or all operations of the method, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the processes 500 and/or 600 can be implemented, at least in part, by modules running the features disclosed herein can be a dynamically linked library, a statically linked library, and functionality produced by an application programing interface, a compiled program, an interpreted program, a script, or any other executable set of instructions. Data can be stored in a data structure in one or more memory components. Data can be retrieved from the data structure by addressing links or references to the data structure.

Although the illustration may refer to the components of the figures, it should be appreciated that the operations of the processes 500 and/or 600 may also be implemented in other ways. In addition, one or more of the operations of the processes 500 and/or 600 may alternatively or additionally be implemented, at least in part, by a chipset working alone or in conjunction with other software modules. In the example described below, one or more modules of a computing system can receive and/or process the data disclosed herein. Any service, circuit, or application suitable for providing the techniques disclosed herein can be used in operations described herein.

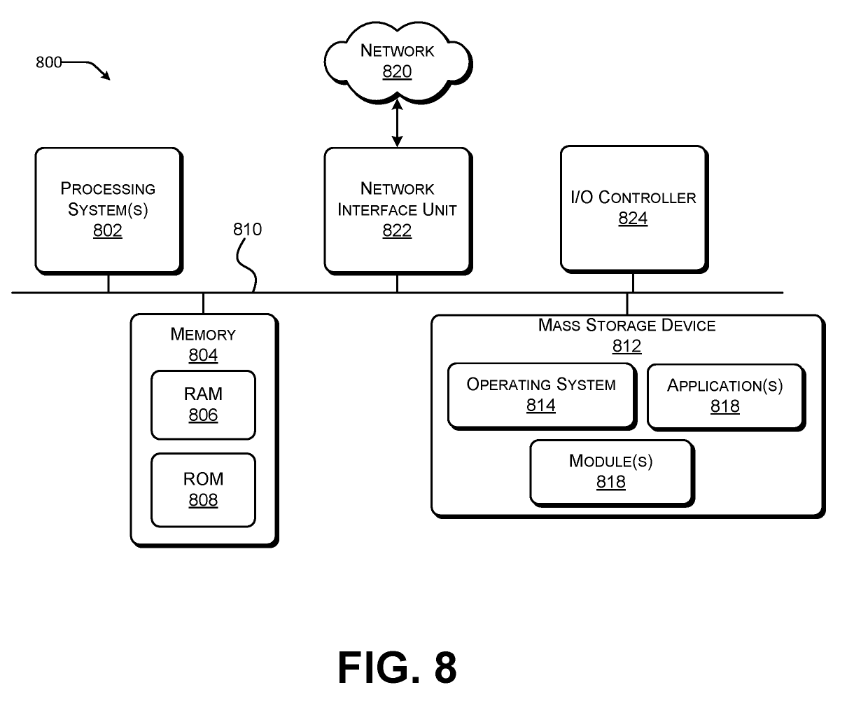

FIG. 8 shows additional details of an example computer architecture 800 for a device, capable of executing computer instructions (e.g., a module or a program component described herein). The computer architecture 800 illustrated in FIG. 8 includes processing system 802, a system memory 804, including a random-access memory 806 (RAM) and a read-only memory (ROM) 808, and a system bus 810 that couples the memory 804 to the processing system 802. The processing system 802 comprises processing unit(s). In various examples, the processing unit(s) of the processing system 802 are distributed. Stated another way, one processing unit of the processing system 802 may be located in a first location (e.g., a rack within a datacenter) while another processing unit of the processing system 802 is located in a second location separate from the first location. Moreover, the systems discussed herein can be provided as a distributed computing system such as a cloud service.

Processing unit(s), such as processing unit(s) of processing system 802, can represent, for example, a CPU-type processing unit, a GPU-type processing unit, a field-programmable gate array (FPGA), another class of digital signal processor (DSP), or other hardware logic components that may, in some instances, be driven by a CPU. For example, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), and the like.

A basic input/output system containing the basic routines that help to transfer information between elements within the computer architecture 800, such as during startup, is stored in the ROM 808. The computer architecture 800 further includes a mass storage device 812 for storing an operating system 814, application(s) 818, modules 818, and other data described herein.

The mass storage device 812 is connected to processing system 802 through a mass storage controller connected to the bus 810. The mass storage device 812 and its associated computer-readable media provide non-volatile storage for the computer architecture 800. Although the description of computer-readable media contained herein refers to a mass storage device, the computer-readable media can be any available computer-readable storage media or communication media that can be accessed by the computer architecture 800.

Computer-readable media includes computer-readable storage media and/or communication media. Computer-readable storage media includes one or more of a volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including RAM, static RAM (SRAM), dynamic RAM (DRAM), phase change memory (PCM), ROM, erasable programmable ROM (EPROM), electrically EPROM (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 800 may operate in a networked environment using logical connections to remote computers through the network 820. The computer architecture 800 may connect to the network 820 through a network interface unit 822 connected to the bus 810. The computer architecture 800 also may include an input/output controller 824 for receiving and processing input from a number of other devices, including a keyboard, mouse, touch, or electronic stylus or pen. Similarly, the input/output controller 824 may provide output to a display screen, a printer, or other type of output device.

The software components described herein may, when loaded into the processing system 802 and executed, transform the processing system 802 and the overall computer architecture 800 from a general-purpose computing system into a special-purpose computing system customized to facilitate the functionality presented herein. The processing system 802 may be constructed from any number of transistors or other discrete circuit elements, which may individually or collectively assume any number of states. More specifically, the processing system 802 may operate as a finite-state machine, in response to executable instructions contained within the software modules disclosed herein. These computer-executable instructions may transform the processing system 802 by specifying how the processing system 802 transition between states, thereby transforming the transistors or other discrete hardware elements constituting the processing system 802.

The disclosure presented herein also encompasses the subject matter set forth in the following clauses.

Example Clause A, a method for fact-checking while synthesizing a summary of a text document, the method comprising: receiving, from a computing device, an upload of the text document for summarization; in response to receiving the upload of the text document, extracting, by execution of a first computational model, structured text data from the text document; identifying, by execution of a second computational model, a factual claim conveyed by the structured text data of the text document; deploying an information query to a plurality of trusted sources based on the factual claim to retrieve verified information corresponding to the factual claim; calculating, by execution of the second computational model, a credibility score for the factual claim based on a semantic similarity comparison against the verified information corresponding to the factual claim; determining that the credibility score does not satisfy a threshold credibility score indicating that the factual claim contains inaccurate information; in response to determining that the credibility score does not satisfy the threshold credibility score, synthesizing the summary of the text document, wherein the summary incorporates a correction to the factual claim in accordance with the verified information retrieved via the information query; and delivering the summary of the text document to the computing device, wherein the summary includes a fact-checking report identifying the inaccurate information, the correction in accordance with the verified information that is graphically distinguished from the inaccurate information, and at least one of the plurality of trusted sources.

Example Clause B, the method of Example Clause A, wherein synthesizing the summary of the text document comprises outputting an auditory narration of the summary.

Example Clause C, the method of Example Clause B, further comprising adjusting the auditory narration during output to incorporate the correction in accordance with the verified information.

Example Clause D, the method of any one of Example Clause A through C, wherein each individual trusted source of the plurality of trusted sources is ranked based on a reliability metric that is calculated based on a relevance of the individual trusted source to the factual claim.

Example Clause E, the method of any one of Example Clause A through D, wherein the correction in accordance with the verified information comprises a rephrasing of the factual claim in which inaccurate information is replaced with the verified information.

Example Clause F, the method of any one of Example Clause A through D, wherein the correction in accordance with the verified information comprises a disclaimer that the factual claim contain inaccurate information.

Example Clause G, the method of any one of Example Clause A through D, wherein the correction in accordance with the verified information comprises a statement of the inaccurate information alongside the verified information.

Example Clause H, the method of any one of Example Clause A through G, wherein a modality in which the correction in accordance with the verified information is incorporated in the factual claim is configured by a user preference.

Example Clause I, a system for fact-checking while synthesizing a summary of a text document, the system comprising: a processing unit; and a computer-readable medium having encoded thereon computer-readable instructions that, when executed by the processing unit, cause the system to perform operations comprising: receiving, from a computing device, an upload of the text document for summarization; in response to receiving the upload of the text document, extracting, by execution of a first computational model, structured text data from the text document; identifying, by execution of a second computational model, a factual claim conveyed by the structured text data of the text document; deploying an information query to a plurality of trusted sources based on the factual claim to retrieve verified information corresponding to the factual claim; calculating, by execution of the second computational model, a credibility score for the factual claim based on a semantic similarity comparison against the verified information corresponding to the factual claim; determining that the credibility score does not satisfy a threshold credibility score indicating that the factual claim contains inaccurate information; in response to determining that the credibility score does not satisfy the threshold credibility score, synthesizing the summary of the text document, wherein the summary incorporates a correction to the factual claim in accordance with the verified information retrieved via the information query; and delivering the summary of the text document to the computing device, wherein the summary includes a fact-checking report identifying the inaccurate information, the correction in accordance with the verified information that is graphically distinguished from the inaccurate information, and at least one of the plurality of trusted sources.

Example Clause J, the system of Example Clause I, wherein synthesizing the summary of the text document comprises outputting an auditory narration of the summary.

Example Clause K, the system of Example Clause J, wherein the operation further comprise adjusting the auditory narration during output to incorporate the reconstruction of the incomplete information in accordance with the supplemental information.

Example Clause L, the system of any one of Example Clause I through K, wherein each individual trusted source of the plurality of trusted sources is ranked based on a reliability metric that is calculated based on a relevance of the individual trusted source to the factual claim.

Example Clause M, the system of any one of Example Clause I through L, wherein the correction in accordance with the verified information comprises a rephrasing of the factual claim in which inaccurate information is replaced with the verified information.

Example Clause N, the system of any one of Example Clause I through L, wherein the correction in accordance with the verified information comprises a disclaimer that the factual claim contain inaccurate information.

Example Clause O, the system of any one of Example Clause I through L, wherein the correction in accordance with the verified information comprises a statement of the inaccurate information alongside the verified information.

Example Clause P, the system of any one of Example Clause I through O, wherein a modality in which the correction in accordance with the verified information is incorporated in the factual claim is configured by a user preference.

Example Clause Q, a method for reconstructing incomplete information while synthesizing a summary of a text document, the method comprising: receiving, from a computing device, an upload of the text document for summarization; in response to receiving the upload of the text document, extracting, by execution of a first computational model, structured text data from the text document; identifying, by execution of a second computational model, incomplete information within the structured text data of the text document; deploying an information query to a plurality of trusted sources based on the incomplete information to retrieve supplemental information corresponding to the incomplete information; synthesizing the summary of the text document, wherein the summary incorporates a reconstruction of the incomplete information in accordance with the supplemental information retrieved via the information query; and delivering the summary of the text document to the computing device, wherein the summary includes a reconstruction report identifying the incomplete information, the reconstruction of the incomplete information in accordance with the supplemental information that is graphically distinguished from the incomplete information, and at least one of the plurality of trusted sources.

Example Clause R, the method of Example Clause Q, wherein synthesizing the summary of the text document comprises outputting an auditory narration of the summary.

Example Clause S, the method of Example Clause R, further comprising adjusting the auditory narration during output to incorporate the reconstruction of the incomplete information in accordance with the supplemental information.

Example Clause T, the method of any one of Example Clause Q through S, wherein each individual trusted source of the plurality of trusted sources is ranked based on a reliability metric that is calculated based on a relevance of the individual trusted source to the factual claim.

Conditional language such as, among others, “can,” “could,” “might” or “may,” unless specifically stated otherwise, are understood within the context to present that certain examples include, while other examples do not include, certain features, elements, and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

The terms “a,” “an,” “the” and similar referents used in the context of describing the invention (especially in the context of the following claims) are to be construed to cover both the singular and the plural unless otherwise indicated herein or clearly contradicted by context. The terms “based on,” “based upon,” and similar referents are to be construed as meaning “based at least in part” which includes being “based in part” and “based in whole” unless otherwise indicated or clearly contradicted by context.

In addition, any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method for fact-checking while synthesizing a summary of a text document, the method comprising:
receiving, from a computing device, an upload of the text document for summarization;
in response to receiving the upload of the text document, extracting, by execution of a first computational model, structured text data from the text document;
identifying, by execution of a second computational model, a factual claim conveyed by the structured text data of the text document;
deploying an information query to a plurality of trusted sources based on the factual claim to retrieve verified information corresponding to the factual claim;
calculating, by execution of the second computational model, a credibility score for the factual claim based on a semantic similarity comparison against the verified information corresponding to the factual claim;
determining that the credibility score does not satisfy a threshold credibility score indicating that the factual claim contains inaccurate information;
in response to determining that the credibility score does not satisfy the threshold credibility score, synthesizing the summary of the text document, wherein the summary incorporates a correction to the factual claim in accordance with the verified information retrieved via the information query; and
delivering the summary of the text document to the computing device, wherein the summary includes a fact-checking report identifying the inaccurate information, the correction in accordance with the verified information that is graphically distinguished from the inaccurate information, and at least one of the plurality of trusted sources.

2. The method of claim 1, wherein synthesizing the summary of the text document comprises outputting an auditory narration of the summary.

3. The method of claim 2, further comprising adjusting the auditory narration during output to incorporate the correction in accordance with the verified information.

4. The method of claim 1, wherein each individual trusted source of the plurality of trusted sources is ranked based on a reliability metric that is calculated based on a relevance of the individual trusted source to the factual claim.

5. The method of claim 1, wherein the correction in accordance with the verified information comprises a rephrasing of the factual claim in which inaccurate information is replaced with the verified information.

6. The method of claim 1, wherein the correction in accordance with the verified information comprises a disclaimer that the factual claim contain inaccurate information.

7. The method of claim 1, wherein the correction in accordance with the verified information comprises a statement of the inaccurate information alongside the verified information.

8. The method of claim 1, wherein a modality in which the correction in accordance with the verified information is incorporated in the factual claim is configured by a user preference.

9. A system for fact-checking while synthesizing a summary of a text document, the system comprising:
a processing unit; and
a computer-readable medium having encoded thereon computer-readable instructions that, when executed by the processing unit, cause the system to perform operations comprising:
receiving, from a computing device, an upload of the text document for summarization;
in response to receiving the upload of the text document, extracting, by execution of a first computational model, structured text data from the text document;
identifying, by execution of a second computational model, a factual claim conveyed by the structured text data of the text document;
deploying an information query to a plurality of trusted sources based on the factual claim to retrieve verified information corresponding to the factual claim;
calculating, by execution of the second computational model, a credibility score for the factual claim based on a semantic similarity comparison against the verified information corresponding to the factual claim;
determining that the credibility score does not satisfy a threshold credibility score indicating that the factual claim contains inaccurate information;
in response to determining that the credibility score does not satisfy the threshold credibility score, synthesizing the summary of the text document, wherein the summary incorporates a correction to the factual claim in accordance with the verified information retrieved via the information query; and
delivering the summary of the text document to the computing device, wherein the summary includes a fact-checking report identifying the inaccurate information, the correction in accordance with the verified information that is graphically distinguished from the inaccurate information, and at least one of the plurality of trusted sources.

10. The system of claim 9, wherein synthesizing the summary of the text document comprises outputting an auditory narration of the summary.

11. The system of claim 10, wherein the operation further comprise adjusting the auditory narration during output to incorporate the reconstruction of the incomplete information in accordance with the supplemental information.

12. The system of claim 9, wherein each individual trusted source of the plurality of trusted sources is ranked based on a reliability metric that is calculated based on a relevance of the individual trusted source to the factual claim.

13. The system of claim 9, wherein the correction in accordance with the verified information comprises a rephrasing of the factual claim in which inaccurate information is replaced with the verified information.

14. The system of claim 9, wherein the correction in accordance with the verified information comprises a disclaimer that the factual claim contain inaccurate information.

15. The system of claim 9, wherein the correction in accordance with the verified information comprises a statement of the inaccurate information alongside the verified information.

16. The system of claim 9, wherein a modality in which the correction in accordance with the verified information is incorporated in the factual claim is configured by a user preference.

17. A method for reconstructing incomplete information while synthesizing a summary of a text document, the method comprising:
receiving, from a computing device, an upload of the text document for summarization;
in response to receiving the upload of the text document, extracting, by execution of a first computational model, structured text data from the text document;
identifying, by execution of a second computational model, incomplete information within the structured text data of the text document;
deploying an information query to a plurality of trusted sources based on the incomplete information to retrieve supplemental information corresponding to the incomplete information;
synthesizing the summary of the text document, wherein the summary incorporates a reconstruction of the incomplete information in accordance with the supplemental information retrieved via the information query; and
delivering the summary of the text document to the computing device, wherein the summary includes a reconstruction report identifying the incomplete information, the reconstruction of the incomplete information in accordance with the supplemental information that is graphically distinguished from the incomplete information, and at least one of the plurality of trusted sources.

18. The method of claim 17, wherein synthesizing the summary of the text document comprises outputting an auditory narration of the summary.

19. The method of claim 18, further comprising adjusting the auditory narration during output to incorporate the reconstruction of the incomplete information in accordance with the supplemental information.

20. The method of claim 17, wherein each individual trusted source of the plurality of trusted sources is ranked based on a reliability metric that is calculated based on a relevance of the individual trusted source to the factual claim.
